(19) United States
(12) Patent Application Publication
(10) Pub. No.: US 2026/0236614 A1
(43) Pub. Date: Aug. 13, 2026

(54) DEVICE AND METHOD FOR PREPARING A TRANSPORT OF A DOCUMENT OF VALUE, DEVICE AND METHOD FOR CHECKING THE AUTHENTICITY OF AN INVALIDATED DOCUMENT OF VALUE, SYSTEM AND METHOD FOR DESTROYING A DOCUMENT OF VALUE

(71) Applicant: Giesecke+Devrient Currency Technology GmbH, Munchen (DE)

(72) Inventor: Philipp EDLER, Munchen (DE)

(21) Appl. No.: 19/536,511

(22) Filed: Feb. 11, 2026

(30) Foreign Application Priority Data
Feb. 11, 2025 (DE) 10 2025 104 921.1

(51) Int. Cl. G06F 21/64; G06F 16/93; G06F 21/60; G06Q 10/10; G07D 7/12

(52) U.S. Cl. CPC G06F 21/64; G06F 16/93; G06F 21/608; G06Q 10/10; G07D 7/12

(57) ABSTRACT

Among other things, a device for preparing a transport of a document of value is provided. The device comprises: a receiving unit for receiving the document of value; an invalidation unit, configured to invalidate the document of value in an irreversibly visible manner; a collecting unit for depositing the invalidated document of value for transport; a sensor unit, configured to acquire sensor data which identify the document of value; and a control unit. The control unit is configured to register the document of value based on the sensor data in a fixed entry on a database after invalidation of the document of value.

### BACKGROUND

The present invention relates to a device for preparing a transport of a document of value, a device for checking the authenticity of an invalidated document of value and a system, comprising both devices, for destroying a document of value. The invention further relates to methods corresponding to the respective devices.

Documents of value are understood to be sheet-like objects which, for example, represent a monetary value or an authorization and therefore are not intended to be able to be produced arbitrarily by unauthorized persons. They therefore have security features which are not easy to produce, in particular to copy, and the presence of which is an indication of the authenticity, i.e. the production by a body authorized thereto. Documents of value may have different types of document of value. Important examples of such types of document of value are coupons, vouchers, checks, passports, identity cards, driver's licenses and, in particular, banknotes. In the case of banknotes, further distinctions can be made between types of document of value; within the scope of the present invention, a type of document of value may be given by the currency and the nominal value of a banknote or the denomination and, if appropriate, the issue or the period in which they were issued officially, for example by central banks. Insofar as the following explanations relate to banknotes, they apply accordingly to every other type of document of value.

The value of a document of value is usually composed of two components: the nominal value, e.g. financial value, and the physical value. The physical value represents the value of the physical product of a document of value, e.g. the paper of a banknote, and depends on the state of the document of value. By contrast, the nominal value is represented by the document of value, for example, a monetary amount of a banknote.

Documents of value, in particular banknotes, are subject to particular security requirements during transport on account of their nominal value, in order to prevent unauthorized access. Said security requirements cause considerably higher transport costs than the correspondingly pure logistical costs. Typical transport scenarios include, for example, a return of surplus cash from dealers and/or commercial banks to the central bank; a return of worn or damaged banknotes to the central bank, in order to be checked for authenticity and quality; and in the case of currency changeovers. Said transports are generally carried out by specialized security service providers with armored vehicles, in order to ensure the security of the cash.

A physical irreversible invalidation currently takes place only at the central bank.

It is known from each one of WO 2007/061 377 A1 and WO 2014/077 754 A1 that banknotes are registered as locked in the system before their transport based on their identifier, in order to reduce the risk of theft.

Furthermore, it is known from EP 0 314 999 A2 that banknotes are invalidated before transport by means of contactless imprints, e.g. by means of an inkjet printer, wherein the imprints are checked for completeness by a downstream marking sensor. Such contactless imprints are intended to prevent, with respect to invalidation perforations or stamped invalidation imprints, banknote jams arising during an invalidation of banknotes at usually high clock frequencies in the banknote processing.

Furthermore, banknote neutralization systems are known, which secure the transport of banknotes by virtue of the latter spraying security ink onto the banknotes in the event of unauthorized access, as a result of which the banknotes are permanently marked and become unusable as a means of payment.

In principle, in the previously known processes for preparing the transport of documents of value, in particular banknotes, the nominal value can generally be credited only after physical receipt at the recipient and the verification thereof of the document of value.

### SUMMARY

The invention is therefore based on the object of simplifying existing processes and devices for preparing the transport. The invention is further based on the object of providing a device, a system and methods corresponding to the device and/or system in order to democratize the preparation of the transport of documents of value, i.e. to make it accessible to everyone. The invention is further based on the object of enabling a faster transmission of a nominal value of the document of value from recipient to sender during the transport of the document of value. It is a further object of the invention to improve security measures in the outpayment of the monetary value of invalidated banknotes.

In one aspect of the present disclosure, a device for preparing a transport of a document of value is provided. The device comprises: a receiving unit for receiving the document of value; an invalidation unit, configured to invalidate the document of value in an irreversibly visible manner; a collecting unit for depositing the invalidated document of value for transport; a sensor unit, configured to acquire sensor data which identify the document of value; and a control unit. The control unit is configured to register the document of value based on the sensor data in a fixed entry on a database after invalidation of the document of value.

In a further aspect of the present disclosure, a device for checking the authenticity of an invalidated document of value, in particular a banknote, is provided. The device comprises: a storage device in which instructions for executing an evaluation method are stored; a sensor unit, configured to acquire sensor data which identify the document of value, wherein the document of value has a predetermined number of security elements; an evaluation unit, configured to verify an authenticity of the invalidated document of value based on the instructions. The verifying comprises verifying at least one of the security elements from the predetermined number of security elements based on the sensor data; and verifying an invalidation of the document of value.

In a further aspect of the present disclosure, a method for destroying a document of value is provided. The method comprises in the following order: irreversible and visible invalidation of the document of value; registering the invalidated document of value in a fixed entry of a database; transporting the invalidated document of value; verifying the authenticity of the invalidated document of value; and destroying the document of value. By means of this order (first invalidation, then registration), the number of incorrect entries in the database can advantageously be reduced.

In a further aspect of the present disclosure, a method for checking the authenticity of an invalidated document of value is provided. The method comprises: supplying the invalidated document of value; acquiring sensor data which identify the document of value, wherein the sensor data optionally comprise an identifier of the document of value and a value of the document of value, wherein the identifier of the document of value comprises the value of the document of value; verifying at least one of the security elements from the predetermined number of security elements based on the sensor data; and verifying an invalidation of the document of value.

In a further aspect of the present disclosure, a method for preparing a transport of a document of value is provided. The method comprises: supplying a document of value; invalidating the document of value by: destroying a predetermined security element of the document of value; and/or removing a section, optionally a predetermined pattern, from the document of value; and/or changing a printed image of the document of value; acquiring sensor data which identify the document of value; and registering the invalidated document of value in a fixed entry of a database based on the sensor data.

In a further aspect of the present disclosure, a system for destroying documents of value is provided. The system comprises a device for preparing a transport of a document of value according to one aspect of the present disclosure; a database in which fixed entries can be stored; a transport device for transporting the invalidated document of value; and a device for processing the invalidated document of value. The device for processing the invalidated document of value comprises a device for checking the authenticity of the invalidated document of value according to one aspect of the present disclosure; and a device for destroying the invalidated document of value.

The invention is based on the concept of invalidating documents of value in a value-transmitting manner, i.e. decoupling the nominal value of a document of value from the document of value, as a result of which the value of the document of value becomes negligible, with the result that the document of value can be transported more simply and more cost-effectively. In particular in an embodiment in which recipient and sender (owner) know one another or trust one another, the decoupled value can be transmitted contactless, optionally by the recipient, to the owner (sender) of the document of value before the receipt of the document of value at the recipient. In an alternative embodiment in which, in particular, recipient and sender (=owner) of the document of value do not know one another or the relationship thereof is not trustworthy, the decoupled value of the document of value can be credited only after receipt of the invalidated document of value at the recipient. In particular as a result of the invalidated document of value being registered in a fixed entry on a database, the assignment of the nominal value to the owner cannot be manipulated, even in the event of unauthorized access to the invalidated document of value.

An irreversible visible invalidation is, in the context of the present disclosure, an invalidation which irreversibly changes the state of the document of value, for example physically, for instance by removing a portion of the document of value, or chemically, for instance by changing the color image of the document of value. The invalidation is visible, i.e. obvious, and can be recognized by anyone without technical aids. Therefore, the invalidated state of the document of value can be determined immediately and unambiguously at any time. As a result of the irreversible invalidation, it can further be ensured that the invalidated banknotes no longer have a potential value for third parties.

As a result of the combination of local irreversible invalidation of the document of value, in particular banknotes, and digital processing or compensation of the nominal value of the document of value, the recirculation of documents of value could be further promoted. In this case, in particular an instantaneous crediting of the nominal value and a return transport, decoupled in time therefrom, e.g. to the central bank, can further be advantageous with resource-saving logistics concepts. Based on the core of the invention, a single-use cash can be created for banknotes as documents of value. This embodiment can be advantageous particularly in cash cycles with very sparse infrastructure, since each dealer himself does not have to transport away small amounts of cash in a cost-consuming manner, but can essentially invalidate himself and then send them back to the central bank “by post”. Furthermore, an end user could make the depositing of cash virtually at the kitchen table, by physically invalidating the corresponding banknote itself, for example punching it out, sufficiently verifying the authenticity of the invalidated banknote by means of a mobile terminal, for instance a smartphone (assuming that known methods for checking the authenticity of an invalidated banknote with the aid of a smartphone are sufficiently reliable), and finally sending the invalidated banknotes to the bank. In one embodiment, the invalidated banknotes could even be forwarded via a plurality of stages, since at least one security feature of the banknote can still remain usable physically, wherein the nominal value can be digitally transferred based on the fixed entry of the database, for example by transactions in the database.

The devices, methods and/or the system can further comprise one or more of the following features.

The receiving unit can be configured to receive a plurality of documents of value. The device can further comprise a feeding unit for feeding individual or separated documents of value to the invalidation unit.

The device for preparing a transport of a document of value can be designed as a banknote processing machine and/or as a bank/automated teller machine (ATM/cash recycler).

The database can be designed as a blockchain. The database can be designed as a register of a cryptocurrency, wherein the fixed entry can be represented by a token. The database can be designed as a generic database which is stored in a fixed memory area. For this purpose, the device for preparing a transport can comprise a memory device which comprises a fixed memory area. The fixed memory area can be designed as a write-once-read-many (WORM) memory. In an alternative embodiment, access to the memory is regulated via a permission administration by means of which, for example, it is defined who has write permission for writing in the memory area and/or who has deletion permission for erasing in the memory area. Optionally, only the central bank may erase in the memory area. The write permission is, if appropriate, assigned by the central bank, optionally after prior authentication, and further optionally, the write permission only applies for a certain period of time, that is to say has an expiry date.

The device for preparing a transport of the document of value can further comprise a contact input unit for inputting a contact of the owner of the document of value or the plurality of documents of value. The control unit can further be configured to register the contact of the owner in relation to the sensor data in the fixed entry on the database.

The contact of the owner can comprise an address, a telephone number, an account number, an IBAN, a token contact address and/or a wallet address. In one embodiment, the wallet can be anonymous.

The sensor data can comprise an identifier of the document of value and a value, in particular nominal value, of the document of value. Optionally, the identifier of the document of value can comprise the value of the document of value. The identifier of the document of value can be a serial number which uniquely identifies the document of value worldwide. In the case of a banknote, the serial number can comprise the nominal value of the banknote. The sensor data can be the identifier of the document of value, for example a machine-readable serial number.

The sensor unit can comprise a camera, wherein the sensor data can be the image of the camera. The sensor data can comprise or be a machine-readable code which uniquely identifies the document of value. For this purpose, the sensor unit can comprise, for example, a magnetic sensor and/or an optical sensor.

The control unit can comprise an interface for receiving the sensor data. The control unit can comprise a processor. The control unit can further comprise the memory unit.

The device for preparing a transport of the document of value can further comprise a memory unit in which the database is stored. As a result, the entry in the database can be processed locally in the device. The memory unit can comprise a fixed memory area.

The device for preparing a transport of the document of value can further comprise a communication unit for data communication with an external server. The database can be managed on the external server. The control unit can further be configured to transmit the sensor data, optionally the identifier, of the document of value and/or the contact of the owner to the external server via the communication unit.

Further data can be acquired in the database, in particular in conjunction with the fixed entry which identifies the document of value. Said further data can be provided by the owner, for example by means of an input unit and/or the contact input unit or can be determined or provided by means of the control unit. Said further data can comprise tracking-related logistics information, certificates of the device and/or banknote processing machine, time stamps of the devaluing process and/or geographical information. The further data can be stored together based on the sensor data in the fixed entry of the database. The further data can be used for outpayment of the nominal value of the document of value, in particular by a so-called smart contract (hereinafter also referred to as “self-executing contract”). The (process) security can be further increased by the further data.

In one embodiment, the writing in the fixed entry of the database can be subject to input control. This input control can comprise the presentation of a predetermined certificate by the control unit of the device for preparing a transport. The fixed entry in the database can have an expiry date. If the expiry date is exceeded, for example after 12 months, the entry in the database can be erased without crediting the value (automatic erasing of incorrect entries in the database).

The control unit can be configured to store a digital copy or a digital twin of the invalidated document of value in the fixed entry of the database. The digital copy can be linked to a self-executing contract in the fixed entry of the database.

The control unit can further be configured to provide instructions for initiating an outpayment of the value of the document of value to the contact of the owner. The instructions for initiating an outpayment can comprise the value or nominal value of the document of value, for example, the monetary amount of a banknote, the identifier of the document of value, for example, the serial number of a banknote, and outpayment-relevant information, such as the contact of the owner.

The control unit can further be configured to register, based on the identifier, a self-executing contract in the fixed entry of the database. The self-executing contract can contain instructions for initiating an outpayment of the value of the document of value to the contact of the owner. The instructions can contain a condition for outpayment of the value of the document of value to the contact of the owner. The condition can comprise a successful authenticity check of the document of value. The self-executing contract can comprise an “if-then” link, in particular a rule of the type “if the invalidated document of value is genuine, then the nominal value of the document of value is paid out”. The self-executing contract can be designed as a smart contract.

In one embodiment, the instructions for outpayment of the nominal value of the invalidated document of value can comprise a rule according to which document of value owners known to the recipient of the invalidated document of value receive an instantaneous outpayment, i.e. before the invalidated document of value has physically arrived at the recipient and could be verified. In this case, the outpayment can take place immediately after registration of the invalidated document of value in the database. The transport of the invalidated document of value and the authenticity check of the invalidated document of value can take place accordingly downstream.

The database can have an interface for status queries, e.g. based on the identifier of the document of value. The status queries can deliver, for example, indications of a location (for instance by means of tracking information stored in the database) of the invalidated documents of value. If the database is stored in the memory unit of the transport preparation unit, an input unit (e.g. the contact input unit) can be configured to receive the status query and forward it to the control unit or the database for further processing. If the database is stored externally, i.e. in a database unit, the interface can be provided by the database unit. Such status queries can increase the transparency of the document of value destruction system and thereby improve its acceptance and security. The status queries could be of interest in particular for cash-in-transport (CIT) companies and/or banks.

The invalidation unit can be configured to invalidate the document of value as follows: destroying a predetermined security element of the document of value; and/or removing a section, optionally a predetermined pattern, from the document of value, e.g. by punching; and/or changing a printed image of the document of value. The invalidation of the document of value takes place as a result of targeted physical and/or chemical manipulation or change of the appearance of the document of value.

The document of value can have a plurality of security elements. The physical invalidation, for example destruction, of a predetermined security element of the document of value can take place, for example, by punching or stamping. Alternatively, this physical invalidation takes place by means of a laser. After the invalidation, the document of value can have a destroyed security element and a plurality of intact security elements. As a result of a predetermined combination of destroyed and intact security elements, the authenticity of the invalidated document of value can be efficiently verified.

In one exemplary embodiment, the document of value can comprise an optically variable printing ink, OVI, which specifies the nominal value of the document of value, wherein the destruction of a predetermined security element of the document of value comprises a cutting, punching and/or stamping of the OVI. For example, a corner of the document of value in which the emerald number is arranged can be severed or cut off. The absence of the OVI as a deactivation feature can be determined particularly efficiently in an authenticity verification of the invalidated document of value. Instead of or in combination with the emerald number, a hologram, a watermark, a gloss strip, a security thread, a tactile printed image and/or a printed UV element or an IR element on the document of value can be at least partially or completely destroyed for the physical invalidation of the document of value.

The removal of a section, optionally a predetermined pattern, from the document of value can comprise the removal of a predetermined security element. The section, optionally the predetermined pattern, should have an extent which promotes the obviousness of the invalidation. For example, if the document of value has two serial numbers, one can be removed or punched out therefrom.

The invalidation unit can comprise a laser processing head, which is configured to remove or cut out parts of the document of value.

The device for verifying the authenticity of an invalidated document of value can further comprise a control unit, configured to transmit a confirmation of the authenticity of the invalidated document of value to an external server based on a successful authenticity check of the invalidated document of value.

The control unit of the device for verifying the authenticity of the invalidated document of value can write the confirmation of the authenticity of the invalidated document of value into a further fixed entry of the database. The further entry can be set in conjunction with the entry based on the sensor data of the invalidated document of value and/or the instructions for outpayment of the nominal value of the invalidated document of value. If the document of value has been invalidated without registration, for example, randomly or deliberately (torn banknote), the entry based on the confirmation of the authenticity cannot be set in conjunction with a corresponding entry based on the sensor data. In this case, no outpayment of the nominal value of the banknote can take place, but rather the invalidated banknote would have to be replaced, which is usually the case.

Each entry in the database can be secured by a cryptographic secret. The cryptographic secret can be generated, for example, by the respective control unit based on the sensor data. For this purpose, the control unit can determine a random physical marker and/or a current time stamp or a randomly selected piece of publicly inaccessible information from the invalidating process and write it in combination with the respective (useful) data into the fixed entry of the database. This securing can relate both to the device for preparing a transport and to the device for authenticity verification.

The evaluation unit of the device for authenticity verification of an invalidated document of value can be configured to verify the invalidation of the document of value as follows: detecting a destruction of a predetermined security element of the document of value; and/or detecting a removal of a section, optionally a predetermined pattern, from the document of value; and/or detecting a change of a printed image of the document of value, in particular by comparing the sensor data with reference data of the printed image.

The sensor unit of the device for authenticity verification can be coupled to the evaluation unit via a data interface. The sensor unit can be configured to acquire the sensor data of the invalidated document of value by changing a measurement position on the document of value along one of at least two tracks, optionally parallel tracks, and to transmit the sensor data to the evaluation unit, optionally in real time.

The method for destroying the document of value can further comprise: initiating an outpayment of the value of the document of value after the irreversible and visible invalidation of the document of value.

The registering of the invalidated document of value can further comprise:

acquiring sensor data which identify the document of value; and registering the document of value in the fixed entry of the database based on the sensor data. The sensor data can optionally comprise an identifier of the document of value and a value of the document of value. The identifier of the document of value can comprise the value of the document of value.

The identifier of the document of value can be a serial number which uniquely identifies the document of value worldwide. In the case of a banknote, the serial number can comprise the nominal value of the banknote or reference it to it. The identifier can be applied only upon invalidation, for example by applying an identification number or identification pattern (e.g. QR code) by means of lasers, imprints or manual inscription. In this case, a machine readability of the identifier would be advantageous.

The document of value can have a predetermined number of security elements.

The method for checking the authenticity of an invalidated document of value can further comprise: detecting a destruction of a predetermined security element of the document of value; and/or detecting a removal of a section, optionally a predetermined pattern, from the document of value; and/or detecting a change of a printed image of the document of value, in particular by comparing the sensor data with reference data of the printed image.

The method can further comprise: transmitting a confirmation of the authenticity of the invalidated document of value based on a successful authenticity check of the invalidated document of value.

The method can further comprise: receiving a contact of an owner of the document of value; and registering the contact of the owner in relation to the sensor data in the database.

The method for destroying documents of value can further comprise: generating instructions for initiating an outpayment of the value of the document of value to the contact of the owner; and/or providing the instructions, optionally by registering a self-executing contract for outpayment of the value of the document of value to the contact of the owner conditional on a successful authenticity check of the document of value, in the fixed entry of the database.

In one embodiment, the document of value can comprise a chip or a circuit, in particular RFID circuit, in order to store digital information on the document of value. In this case, the identifier of the document of value can be an identifier or “unique identifier” which is stored on the document of value and is machine-readable and can thereby be acquired more simply, both in the invalidation and in the authenticity check.

In one embodiment according to which the document of value comprises a circuit, a cryptographic certificate and/or a private part of a cryptographic key can be stored on the document of value. In this case, each document of value can comprise an individual cryptographic key, based on which the entry in the database can be secured. For this purpose, a mechanism can be provided in the database according to which the same cryptographic key may be used in each case only exactly once for registering the invalidated document of value, with the result that the same invalidated document of value cannot be registered multiple times.

The invention or further embodiments and advantages of the invention are explained in more detail below with reference to drawings, wherein the drawings describe only embodiments of the invention. Identical components are provided with the same reference signs in the drawings. Elements which are drawn using dashed lines are considered to be optional elements.

### BRIEF DESCRIPTION OF THE DRAWINGS

The drawings are not to be regarded as true to scale, and individual elements of the drawings can be illustrated with an exaggerated size or in an exaggerated simplified manner. In the figures:

FIG. 1 shows an example of a schematic design of a device for preparing a transport of a document of value;

FIG. 2 shows an example of a schematic design of a device for checking the authenticity of an invalidated document of value;

FIG. 3 shows an example of a schematic design of a system for destroying documents of value;

FIG. 4 shows an example of a schematic flow diagram of a method for destroying documents of value with corresponding crediting;

FIG. 5 shows an example of a schematic flow diagram of a method for preparing a transport of a document of value;

FIG. 6 shows an example of a schematic flow diagram of a method for checking the authenticity of an invalidated document of value.

### DETAILED DESCRIPTION OF VARIOUS EMBODIMENTS

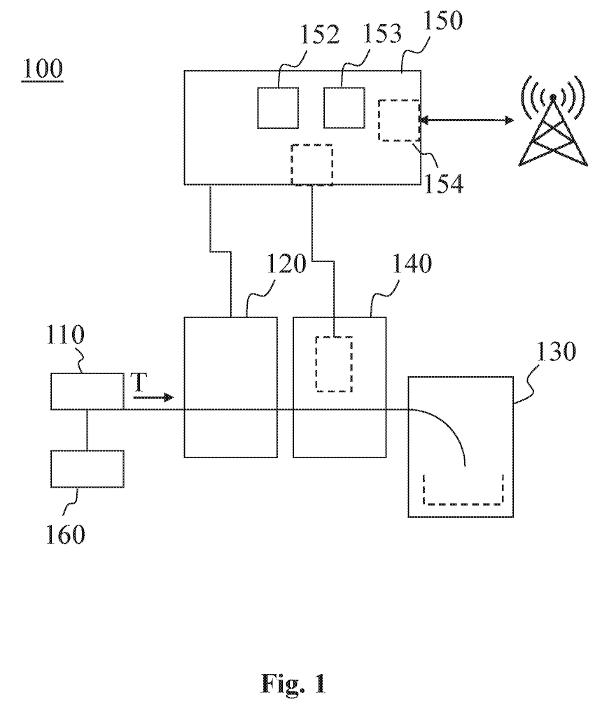

A document value processing device in FIG. 1, in the example designed as a device 100 for preparing a transport of a document of value, is designed for irreversible and visible invalidation and subsequent registration of the invalidated document of value.

The device 100 can comprise a receiving unit 110 for receiving documents of value, a collecting unit 130 for delivering or depositing processed, i.e. invalidated and registered, documents of value, and a transport unit (not shown) for transporting individual or separated documents of value from the receiving unit 110 to the collecting unit 130 along the transport direction T.

On the transport path between the receiving unit 110 and the collecting unit 130, an individual or separated document of value can pass through an invalidation unit 120 for invalidating the document of value. The invalidation unit can be configured to invalidate the document of value irreversibly and obviously by removing a part of the document of value, e.g. by (laser) stamping, punching, cutting, etc., and/or chemically, for instance by a color change of the document of value. The invalidation unit 120 can be controlled by a control unit 150.

The control unit 150 can comprise a memory unit 152, wherein instructions can be stored in the memory unit 152 which, when executed by the control unit 150, for example, cause the invalidation unit 120 to carry out an invalidating process. A database (not shown) can further be stored in the memory unit 152, in which fixed entries can be stored. The control unit 150 can further comprise a processor 153. The control unit 150 can comprise a communication interface 154. By means of the communication interface 154, the control unit 150 can establish a data communication with an external server, for example, in order to write data into fixed entries of an external database (not shown).

The device 100 further comprises a sensor unit 140 having at least one sensor which is symbolized by a dashed box in FIG. 1. The sensor unit 140 can comprise an optical sensor, for example, a camera, and/or a magnetic sensor. The sensor unit 140 is configured to acquire sensor data which identify the document of value. These sensor data can comprise or be an identifier, e.g., a serial number.

The control unit is configured to register the document of value based on the sensor data in a fixed entry on a database (not shown) after invalidation of the document of value. As a result of this registration, the value or nominal value of the document of value can be digitized and decoupled from the invalidated document of value.

The device 100 can further comprise a contact input unit by which the owner can provide his contact. The contact can be stored together with the sensor data in the fixed entry on the database, or can be stored in a further fixed entry which is linked to the entry based on the sensor data.

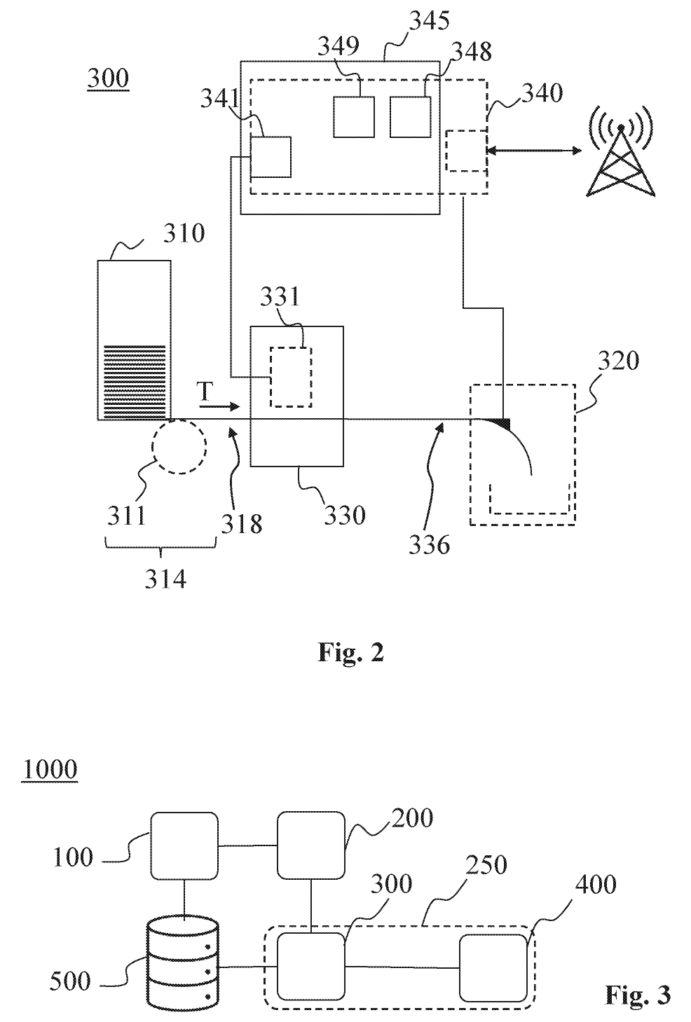

A document value processing device in FIG. 2, in the example designed as a device 300 for verifying the invalidated document of value and for verifying the invalidation of the document of value.

The device 300 can comprise a feeding unit 314 for feeding documents of value, an output unit 320 for delivering or depositing processed, i.e. verified, documents of value, and a transport unit 318 for transporting individual or separated documents of value from the feeding unit 314 to the output unit 320 on the transport path 336 along the transport direction T. The feeding unit 314 can comprise a receiving unit 310 for receiving invalidated documents of value, optionally in a stack, and a separator 311.

On the transport path between the feeding unit 314 or the receiving unit 310 and the output unit 320, an individual or separated invalidated document of value can pass through a sensor unit 330 for acquiring sensor data for checking the authenticity of the invalidated document of value.

The sensor unit 330 can comprise at least one sensor 331, configured to acquire sensor data which reflect the security elements of the document of value. The document of value can have a plurality of security elements, which serve to make the document of value distinguishable from forgeries.

The device 300 can further comprise an evaluation unit 345, configured to verify an authenticity of the invalidated document of value. For this purpose, the evaluation unit 345 can comprise a data interface 341 for receiving the sensor data of the sensor unit 330. The evaluation unit can further comprise a processor 348 and a memory unit 349. Instructions for executing an evaluation method can be stored in the memory unit 349.

The evaluation unit 345 can be configured to verify at least one of the security elements from the predetermined number of security elements based on the sensor data. The evaluation unit 345 can further be configured to verify at least two security elements and/or a predetermined combination of security elements based on the sensor data.

The evaluation unit 345 can be configured to verify an invalidation of the document of value. For this purpose, the evaluation unit 345 can determine deviations in the sensor data with respect to a predetermined security element and/or the appearance of the invalidated document of value in relation to an intact document of value of the same type of document of value. For example, reference data with respect to a predetermined security element and/or the appearance of an intact document of value can be stored in the memory unit 349, which reference data can be used for verifying the invalidation of the document of value. The evaluation unit 345 can be configured to verify the invalidation of the document of value based on a predetermined pattern, in particular a hole pattern. For example, documents of value can be invalidated in the invalidation unit 120 (FIG. 1) by means of a predetermined hole pattern, such as a polygonal hole, a star, a hole with a curved edge, a plurality of holes in a predetermined configuration, etc. The evaluation unit 345 can be configured to search for the corresponding hole pattern in the sensor data of the invalidated document of value and, if present, to confirm the invalidation of the document of value.

The device 300 can further comprise a control unit 340. The control unit 340 can be combined with the evaluation unit 345, i.e., for example, access the same processor 348 and/or the same memory unit 349. The control unit 340 can have a communication unit which is symbolized by a dashed box in FIG. 2. By means of the communication unit, the control unit 340 can establish a data communication with an external server, e.g. with a database unit (not shown). In particular, the control unit 340 can transmit a confirmation of the authenticity of the invalidated document of value to an external server and/or write it into a fixed entry of the database.

FIG. 3 shows an example of a schematic design of a system 1000 for destroying documents of value.

The system 1000 comprises a device 100 for preparing a transport of a document of value, e.g., as described with reference to FIG. 1. The system 1000 further comprises a device 300 for checking the authenticity of an invalidated document of value, e.g., as described with reference to FIG. 2. For the transport of the invalidated document of value after its invalidation by means of the first device 100 to the second device 300, the system comprises a transport device 200. The transport device is not subject to any particular security requirements, since the documents of value to be transported are already invalidated and only have a maximum physical value. The transport device can therefore be implemented or provided by a conventional logistics service provider.

The system 1000 further comprises a device 400 for destroying the invalidated document of value. The device 400 can be a conventional device for destroying documents of value, such as, for instance, in central banks in operation.

The device 300 for checking the authenticity of an invalidated document of value and the device 400 for destroying the invalidated document of value can be combined in a common device for processing the invalidated document of value.

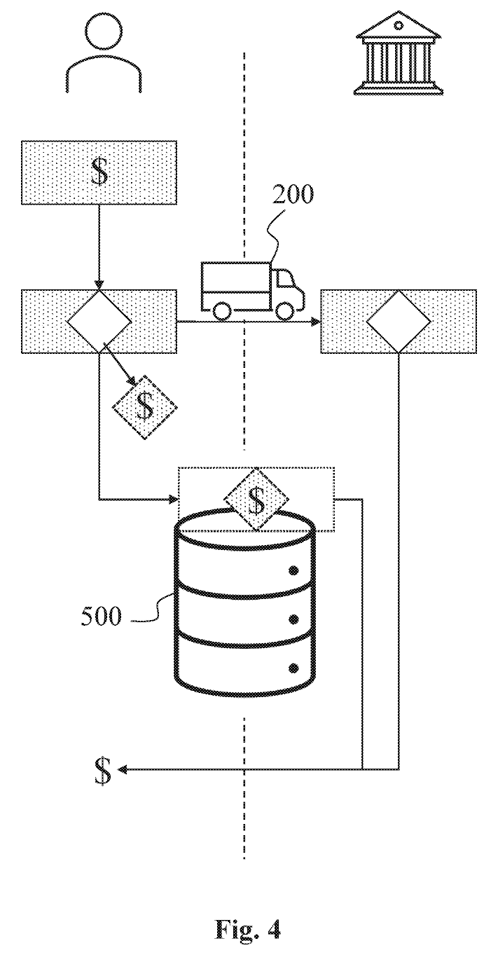

The system 1000 further comprises a database 500 in which fixed entries can be written. The database 500 can be stored in the device 100 for preparing a transport of the document of value, in the device 300 for checking the authenticity of the invalidated document of value and/or on an external server. The database 500 can have corresponding interfaces in order to receive data in each case from the device 100 for preparing a transport of the document of value, in the device 300 for checking the authenticity of the invalidated document of value and/or a terminal of an end consumer. The function of the database 500 is explained in more detail with reference to FIG. 4.

FIG. 4 shows an example of a schematic flow diagram of a method for destroying documents of value with corresponding crediting to the owner of the document of value to be destroyed.

In FIG. 4, the sphere of the owner of the document of value, in the example as a banknote with a monetary value symbolized by a dollar symbol, is illustrated on the left-hand column. The sphere of the central bank is illustrated on the right-hand column in FIG. 4.

The owner has a document of value that he/she wishes to invalidate. For this purpose, the document of value is initially physically invalidated. The document of value can be invalidated by destroying a predetermined security element of the document of value; and/or removing a section, optionally a predetermined pattern, from the document of value; and/or changing a printed image of the document of value. The invalidation can be carried out by means of a device 100 as described with reference to FIG. 1.

Immediately following the invalidation of the document of value, the document of value is identified by machine, namely by acquiring sensor data of the invalidated document of value and evaluating the acquired sensor data. The identifying does not comprise the verifying of the invalidation of the invalidated document of value. The invalidation of the document of value must, however, still allow an identifying of the document of value, i.e. not all available identifiers should be destroyed at the same time during the invalidation.

Based on the sensor data, in particular on the identifier of the invalidated document of value, the invalidated document of value is registered in a fixed entry of a database 500, optionally together with a contact input of the owner. The fixed entry on the database 500 can be linked to a self-executing contract which can likewise be stored in the database 500. By means of the self-executing contract, the monetary value of the invalidated document of value can be fully automatically credited to the owner upon successful authenticity check of the invalidated document of value.

The invalidated document of value, symbolized by a punched-out diamond in FIG. 4, can be transported to the central bank for example by the transport device 200. The central bank or the recipient of the invalidated document of value can, inter alia, verify the authenticity of the invalidated document of value by means of a device 300 as described with reference to FIG. 2. Upon successful verification both of the document of value and of the invalidation of the document of value, a confirmation of the authenticity of the invalidated document of value can be written in a fixed entry on the database 500. In this case, in combination with the fixed entry, it can be determined unambiguously based on the sensor data and/or the contact input that the nominal amount of the invalidated document of value, that is to say, in the example, the monetary amount, is to be credited to the owner. By means of the self-executing contract, such a crediting can be executed e.g. fully automatically and without access by third parties. As a result, the security aspect in the outpayment of the nominal amount of the invalidated document of value can be further improved.

After successful outpayment of the nominal value of the invalidated document of value, the invalidated document of value can be destroyed.

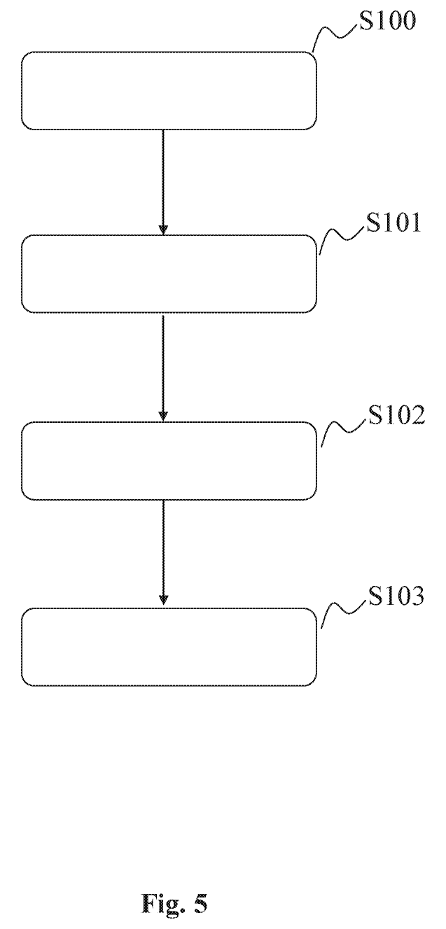

FIG. 5 illustrates an example of a schematic flow diagram of a method for preparing a transport of a document of value.

The method comprises a first method step 100 according to which the document of value to be invalidated is supplied to a document value processing device, for instance the device 100.

The method comprises a second method step 101 according to which the document of value to be invalidated is invalidated, optionally in a document value processing device, for instance the device 100.

The method comprises a third method step 102 according to which sensor data of the invalidated document of value are acquired for identifying the invalidated document of value.

The method comprises a fourth method step 103 according to which the invalidated document of value is registered based on the sensor data, in particular an identifier, in a fixed entry on the database 500.

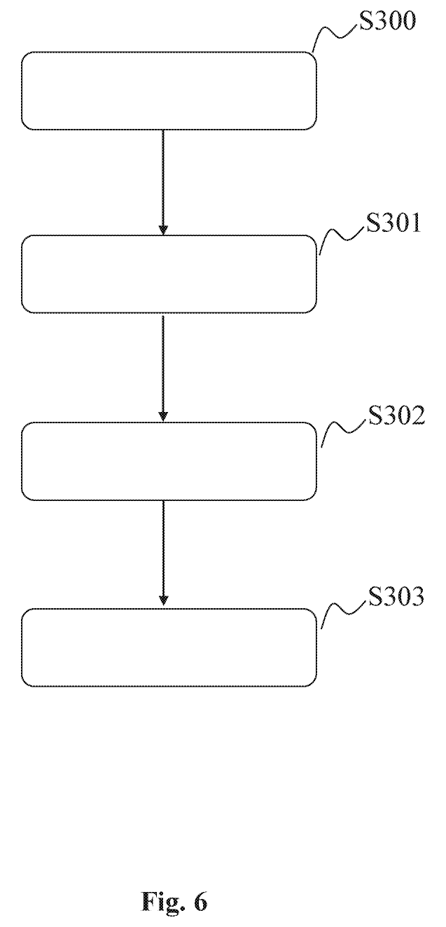

FIG. 6 illustrates an example of a schematic flow diagram of a method for checking the authenticity of an invalidated document of value.

The method comprises a first method step 300 according to which the document of value to be invalidated is supplied to a document value processing device, for instance the device 300.

The method comprises a second method step 301 according to which sensor data of the invalidated document of value are acquired, optionally by means of a sensor unit of a document value processing device, for instance the device 300.

The method comprises a third method step 302 according to which at least one, optionally two or more, of the security elements of the invalidated document of value are verified based on the sensor data of the invalidated document of value.

The method comprises a fourth method step 403 according to which the invalidation of the invalidated document of value is verified based on the sensor data of the invalidated document of value.

By a confirmation of the authenticity of the invalidated document of value, the recipient of the invalidated document of value can initiate the outpayment of the nominal value of the invalidated document of value. For this purpose, a self-executing contract stored in the database 500 can be used, as explained with reference to FIG. 4.

### LIST OF REFERENCE NUMERALS

100 Device for preparing a transport of a document of value

110 receiving unit

120 invalidation unit

130 collecting unit

140 sensor unit

150 control unit

152 memory unit

153 processor of the control unit

154 communication unit

160 contact input unit

200 transport unit

250 device for processing the invalidated document of value

300 device for checking the authenticity of an invalidated document of value

310 receiving unit

311 separator

314 feeding unit

318 transport device

320 output unit

330 sensor unit

331 sensor

336 transport path

340 control unit

341 data interface

345 evaluation unit

348 processor

349 storage device

400 Device for destroying an invalidated document of value

500 database

1000 system

S100 Method step “supplying a document of value”

S101 Method step “invalidating the document of value”

S102

Method step “acquiring sensor data”

S103 Method step “registering the invalidated document of value”

S300 Method step “supplying the invalidated document of value”

S301 Method step “acquiring sensor data”

S302 Method step “verifying at least one of the security elements”

S303

Method step “verifying an invalidation of the document of value”

1. A device for preparing a transport of a document of value, the device comprising:
a receiving unit for receiving the document of value;
an invalidation unit, configured to invalidate the document of value in an irreversibly visible manner;
a collecting unit for depositing the invalidated document of value for transport;
a sensor unit, configured to acquire sensor data which identify the document of value; and
a control unit, configured to register the document of value based on the sensor data in a fixed entry on a database after invalidation of the document of value.

2. The device according to claim 1, wherein the receiving unit is configured to receive a plurality of documents of value, and/or the device further comprises a feeding unit for feeding individual or separated documents of value to the invalidation unit.

3. The device according to claim 1, further comprising a contact input unit for inputting a contact of the owner of the document of value or the plurality of documents of value,
wherein the control unit is further configured to register the contact of the owner in relation to the sensor data in the fixed entry on the database.

4. The device according to claim 1, wherein the sensor data comprises an identifier of the document of value and a value of the document of value.

5. The device according to claim 4, wherein the identifier of the document of value comprises the value of the document of value.

6. The device according to claim 1, further comprising a storage unit in which the database is stored.

7. The device according to claim 1, further comprising a communication unit for data communication with an external server,
wherein the database is managed on the external server, and the control unit is further configured to transmit the sensor data, of the document of value.

8. The device according to claim 3, wherein the control unit is further configured to provide instructions for initiating an outpayment of the value of the document of value to the owner.

9. The device according to claim 3, wherein the control unit is further configured to register, based on the identifier, a self-executing contract for outpayment of the value of the document of value to the owner conditional on a successful authenticity check of the document of value, in the invariable entry of the database.

10. The device according to claim 1, wherein the invalidation unit is configured to invalidate the document of value as follows:
destroying a predetermined security element of the document of value;
removing a section, preferably a predetermined pattern, from the document of value; and/or
changing a printed image of the document of value.

11. A device for checking the authenticity of an invalidated document of value, in particular a banknote, the device comprising:
a storage device in which instructions for executing an evaluation method are stored;
a sensor unit, configured to acquire sensor data which identify the document of value, wherein the document of value has a predetermined number of security elements;
an evaluation unit, configured to verify an authenticity of the invalidated document of value based on the instructions, the verification comprising:
verifying at least one of the security elements from the predetermined number of security elements based on the sensor data; and
verifying an invalidation of the document of value.

12. The device according to claim 11, further comprising a control unit, configured to transmit a confirmation of the authenticity of the invalidated document of value to an external server based on a successful authenticity check of the invalidated document of value.

13. The device according to claim 11, wherein the evaluation unit is configured to verify the invalidation of the document of value as follows:
detecting a destruction of a predetermined security element of the document of value;
detecting a removal of a section, optionally a predetermined pattern, from the document of value; and/or
detecting a change of a printed image of the document of value, in particular by comparing the sensor data with reference data of the printed image.

14. The device according to claim 11, wherein the sensor unit is coupled to the evaluation unit via a data interface and is configured to acquire the sensor data of the invalidated document of value by changing a measurement position on the document of value in each case along one of at least two tracks, optionally parallel tracks, and to transmit the sensor data to the evaluation unit.

15. A method for destroying a document of value, the method comprising in the following order:
invalidating the document of value irreversibly and visibly;
registering the invalidated document of value in a fixed entry of a database;
transporting the invalidated document of value;
verifying the authenticity of the invalidated document of value; and
destroying the document of value.

16. The method according to claim 15, further comprising:
initiating an outpayment of the value of the document of value after the irreversible and visible invalidation of the document of value.

17. The method according to claim 15, wherein the registering of the invalidated document of value further comprises:
acquiring sensor data which identify the document of value,
wherein the sensor data optionally comprise an identifier of the document of value and a value of the document of value,
wherein the identifier of the document of value comprises the value of the document of value; and
registering the document of value in the fixed entry of the database based on the sensor data.

18. The method according to claim 17, further comprising:
receiving a contact of an owner of the document of value; and
registering the contact of the owner in relation to the identifier in the fixed entry of the database.

19. The method of claim 18, further comprising registering instructions for outpayment of the value of the document of value to the owner conditional on a successful authenticity check of the document of value in the fixed entry of the database.

20. The method of claim 15, wherein invalidating the document of value by:
destroying a predetermined security element of the document of value;
removing a section, preferably a predetermined pattern, from the document of value; and/or
changing a printed image of the document of value.
